(19) United States
(12) Patent Application Publication
(10) Pub. No.: US 2015/0248819 A1
(43) Pub. Date: Sep. 3, 2015

(54) COMPUTER-BASED SOLITAIRE GAME WITH STACK-BASED PAY TABLE

(71) Applicant: SOLITAIRUS INC., Gananoque (CA)

(72) Inventors: Cameron M. Uhren, Gananoque (CA); K. C. Flynn, Kitchener (CA); Leonard Parente, Burlington (CA)

(21) Appl. No.: 14/426,576

(22) PCT Filed: Sep. 6, 2013
(86) PCT No.: PCT/IB2013/002655

§ 371 Date: Mar. 6, 2015

Related U.S. Application Data
(60) Provisional application No. 61/697,724, filed on Sep. 6, 2012.

(51) Int. Cl. G07F 17/32

(52) U.S. Cl. CPC G07F 17/3293; G07F 17/3258; G07F 17/3267

(57) ABSTRACT

A computer-based solitaire game which collects a player's fee at the start of the game and pays a player award as a function of a per-card payout award and one or more of the number and/or identities of cards that have been transferred from the card deck on foundation stacks. The game further includes a bonus game feature enabling the player to play a non-solitaire game within the solitaire game on the occurrence of a predetermined triggering event in the solitaire game. The per-card payout award of the solitaire game is determined as a function of an expected number of transferred cards, determined as a function of a discrete probability density function calculated in a multi-game simulation. The number of games in the multi-game simulation may be more than one million games. The simulated games are played by applying a set of ordinally-ranked solitaire game play rules.

### BACKGROUND

The game of solitaire has provided entertainment and relaxation for multitudes of individuals when played either manually as a game with a deck of cards or as a video game. The video game of solitaire is typically played by manipulating images of cards displayed for example on a personal computer, a tablet computer, a personal digital assistant or a smartphone.

The popularity of each of the card game and the video game is arguably supported by the one-on-one interaction that individuals have with either the cards directly or with an image of the cards on a video screen of the personal computer. People do not usually compete with other people in solitaire, but work individually with a particular hand of cards to achieve a desired result. Typically, the most sought after result is to turn over all of the cards and arrange the cards in order of color and rank. To accomplish this task is to win the game. Alternatively, for example in another type of solitaire game, the winner must turn up and remove all cards from a tableau. Removal of cards is based upon rules specific for each solitaire game of this type.

Solitaire generally requires both luck and skill. To win a game of one type of solitaire (Klondike solitaire), a player must turn over all cards of a deck and order the cards according to rank and color in order to then move the cards to rank-ordered “foundation” piles or stacks provided for each suit. The game is won when all cards have been moved to the foundation stacks.

For a conventional video solitaire game, a computer randomly orders the cards according to a conventional random card shuffling algorithm. This type of video solitaire game typically does not include an adjustment for a player's level of skill in playing the game of solitaire. For the manual card game of solitaire, the shuffling of each hand of cards randomizes the order of the cards in the deck.

A manual solitaire game developed by Richard Canfield in the early 20^{th} century included steps of buying a deck of cards for fifty dollars and playing a game of Canfield solitaire. The player received five dollars for each card placed on the foundation stacks at the end of the game. The game is more particularly described in Hoyle's Rules and Games, edited by Albert Moorehead and Geoffrey Mott-Smith, published in 1946. Canfield's game does not appear at present be played in its originally-played form on a modern casino floor, perhaps because of the difficulty and costs associated with administering the game in this form.

With the advent of electronic and networked gaming systems (including Internet gaming systems), it would be more efficient to administer the game of solitaire in an electronic form. However, the complexities of play (including the number of possible outcomes from player moves during a game as contrasted to “single-outcome games” such as video slot machines), have heretofore made it difficult to adequately model such a game in order to set pay-in and payout amounts, and to demonstrate to casino regulators with particularity that casino operators' advantage in the game and likely hold percentages of the pay-in amounts will fall within acceptable limits.

### SUMMARY

Aspects of the present disclosure are directed to methods for operating a computer-based solitaire game. According to an aspect of the present disclosure, a computer-based method of operating a solitaire game is provided which collects a player's fee at the start of the game and pays a player award that is accumulated as cards are moved to the foundation stacks. The per-card payout award is determined as a function of an expected number of transferred cards, which number has been determined as a function of a discrete probability density function calculated from outcomes produced in a multi-game simulation of the solitaire game. The number of games in the multi-game simulation is selected to provide a statistically stable result, in particular to demonstrate to casino regulators with particularity that a game operators' advantage in the game and likely hold percentages of the pay-in amounts will fall within acceptable regulatory limits.

Advantageously and according to another aspect of the present disclosure, the number of simulated games may be on the order of more than one million games.

According to another aspect of the present disclosure, the simulated games may be played by applying an optimum set of ordinally-ranked solitaire game play rules.

According to another aspect of the present disclosure, the per-card payout award may vary as a function of the number of cards transferred during the game.

According to another aspect of the present disclosure, the per-card payout award may vary according to identities of the transferred cards.

According to another aspect of the present disclosure, the per-card payout award may vary according to a distribution of the transferred cards among the foundation stacks.

According to another aspect of the present disclosure, the per-card payout award may be calculated based on the accumulated card transfers to the foundation stack over the course of the game and then paid or applied to a player account at the end of the game. Alternatively, and more preferably, the per-card award may be incrementally calculated and applied to the player account during the game, for example, with each occurrence of a card transfer to one of the foundation stacks.

Other aspects of the present disclosure are directed to methods for operating a computer-based solitaire game that includes a bonus game feature (“game within a game”) which is triggered when a pre-determined wild card is played by a player to an exposed (“up-card”) position (for example, is turned over from a hidden or “down card” position on the draw pile or on one of the card columns). The bonus game may comprise one of a variety of non-solitaire games (for example, including one of a variety of poker-type games). Alternatively, the bonus game feature may be implemented by adapting the rules and awards available in playing the current solitaire game (for example, by launching a timed game feature that pays a premium when time thresholds are met, or by converting the award scheme to a progressive award structure including eligibility to win all or a portion of a progressive jackpot).

Another aspect of the present disclosure is directed to a computer-based method for determining the expected number of transferred cards by means of the multi-game simulation. Each simulated game is played by generating an electronic representation of a randomly-ordered card deck and simulating game play by executing an available card plays according to applicable optimum game play rules selected from a plurality of predetermined ordinally-ranked solitaire game play rules. For each play, an applicable game play rule having a highest ordinal ranking among applicable rules is identified and applied to execute the play. Upon completion of the play, the electronic representation of the play is updated and play continues until the detection of an end of game indication. At game completion, the number of cards transferred to foundation stacks is determined, and information indicative of the number of cards transferred is stored in a memory of the computer. In addition, a statistical indicator (for example, a standard deviation) associated with a discrete probability density function for the number of transferred cards is calculated. Game play continues so long as the statistical indicator fails to meet a predetermined threshold. When game play is ended, an expected value for the number of transferred cards is calculated as a function of the discrete probability density function.

Advantageously and according to another aspect of the present disclosure, estimates of a game operators' house advantage may be calculated in the multi-game simulation as a function of the discrete probability density function, a selected per-card payout award and a selected player's fee.

### BRIEF DESCRIPTION OF THE DRAWING

A more complete understanding of the present disclosure may be realized by reference to the accompanying drawing in which:

FIG. 1A is a perspective drawing depicting an exemplary gaming device according to an aspect of the present disclosure;

FIG. 1B is a schematic drawing depicting an exemplary internet-based gaming system according to an aspect of the present disclosure;

FIG. 2 is a schematic drawing further depicting the gaming device of FIG. 1A;

FIG. 3 is a schematic drawing further depicting an exemplary computer system for use in the internet-based gaming system of FIG. 1B;

FIG. 4A is a flow diagram depicting an exemplary operational overview for playing a computer-based solitaire game according to an aspect of the present disclosure;

FIG. 4B is a flow diagram depicting an exemplary operational overview for playing a bonus game of the a computer-based solitaire game according to an aspect of the present disclosure;

FIG. 5A is a schematic diagram depicting an exemplary display screen for a computer-based solitaire game according to an aspect of the present disclosure;

FIG. 5B is a schematic diagram depicting an exemplary headline display screen for a computer-based solitaire game according to an aspect of the present disclosure;

FIG. 5C is a schematic diagram depicting an exemplary playfield display screen during game play for a computer-based solitaire game according to an aspect of the present disclosure;

FIG. 5D is a schematic diagram depicting an exemplary bonus game display screen at the end of game play for a computer-based solitaire game according to an aspect of the present disclosure;

FIG. 5E is a table depicting an exemplary paytable for a bonus game according to an aspect of the present disclosure;

FIG. 5F is a schematic diagram depicting an exemplary playfield display screen for a computer-based solitaire game according to an aspect of the present disclosure;

FIG. 6 is a flow diagram depicting an exemplary operational overview for playing an Internet gaming system-based solitaire game according to an aspect of the present disclosure;

FIG. 7 is a flow diagram depicting an exemplary operational overview for simulating the play of a computer-based solitaire game according to an aspect of the present disclosure;

FIG. 8 is a flow diagram depicting an exemplary operational overview for executing a rule base used in simulating the play of a computer-based solitaire game according to an aspect of the present disclosure;

FIG. 9 is a table depicting an exemplary outcome for a simulated game the play of a computer-based solitaire game according to an aspect of the present disclosure;

FIG. 10 is a bar diagram depicting a frequency of occurrence for possible numbers of cards transferred to foundation stacks during a simulated game play according to an aspect of the present disclosure, in which successive third cards in a card deck are selected moving three times through the deck;

FIG. 11 is a bar diagram depicting a frequency of occurrence for possible numbers of cards transferred to foundation stacks during a simulated game play according to an aspect of the present disclosure, in which each card in a card deck is selected moving one time through the deck;

FIG. 12 is a first table illustrating payout information based on simulated game play results according to an aspect of the present disclosure; and

FIG. 13 is a second table illustrating payout information based on simulated game play results according to an aspect of the present disclosure.

The illustrative embodiments are described more fully by the Figures and detailed description. The inventions may, however, be embodied in various forms and are not limited to specific embodiments described in the Figures and detailed description.

### DESCRIPTION

The following illustrates the principles of the disclosure. It will thus be appreciated that those skilled in the art will be able to devise various arrangements which, although not explicitly described or shown herein, embody the principles of the disclosure and are included within its spirit and scope.

All examples and conditional language recited herein are principally intended expressly to be only for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any flow charts, flow diagrams, and the like represent various processes which may be substantially represented in a computer readable medium and so executed by a computer or processor, whether or not such computer or processor is explicitly shown.

The functions of the various elements shown in the Figures, including any functional blocks labeled as “processors” or “central processing units,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the drawings are not drawn to scale.

We now provide some non-limiting, illustrative examples that illustrate several operational aspects of various arrangements and alternative embodiments of the present disclosure. Aspects this disclosure are directed to a computer-based method of operating a solitaire game which collects a player's fee at the start of the game and pays a player award as a function of a per-card payout award and one or more of the number and/or identities of cards that have been transferred from the card deck on foundation stacks. The per-card payout award is determined as a function of an expected number of transferred cards, which number has been determined as a function of a discrete probability density function calculated from outcomes produced in a multi-game simulation. The number of games in the multi-game simulation is selected to provide a statistically stable result, and may be on the order of more than one million games. The simulated games are played by applying a set of optimum ordinally-ranked solitaire game play rules.

The number of games in the multi-game simulation is selected to provide a statistically stable result, in particular to demonstrate to casino regulators with particularity that a game operators' advantage in the game and likely hold percentages of the pay-in amounts will fall within acceptable regulatory limits. Estimates of the resultant game operators' house advantage and long-term hold percentages of players' fees may be provided in order to ensure that these fall within acceptable limits as may be required, for example, by associated regulatory groups and commissions.

Aspects of this disclosure are further directed to a bonus game feature (“game within a game”), which is triggered within a solitaire game by the computer when a pre-determined wild card is played to assume an exposed (“up-card”) position (for example, is turned over from a hidden or “down card” position on the draw pile or on one of the card columns). The wild card is preferably randomly selected at or near the time that a randomly-ordered card deck is generated for playing the game. As a result, the wild card may be exposed at any time during game play, or not at all. The bonus game may be presented as one of a variety of non-solitaire games (for example, including a variety of poker-type games. Alternatively, the bonus game feature may be implemented by adapting the rules and awards available in playing the current solitaire game (for example, by launching a timed game feature that pays a premium when time thresholds are met, or by converting the award scheme to a progressive award structure including eligibility to win all or a portion of a progressive jackpot). Additional aspects of this disclosure are directed to a variety of game play features that enhance ease of play and/or play outcome.

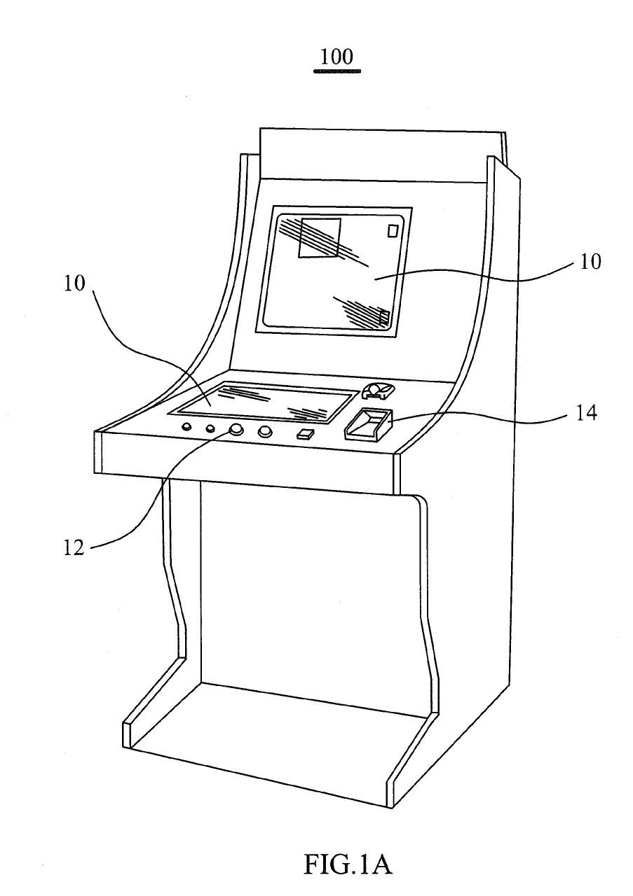

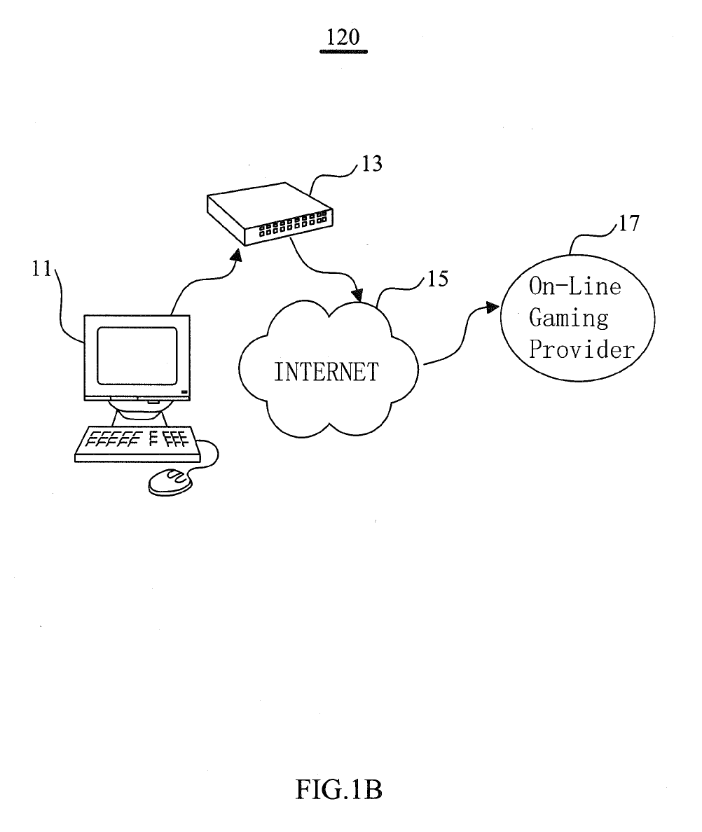

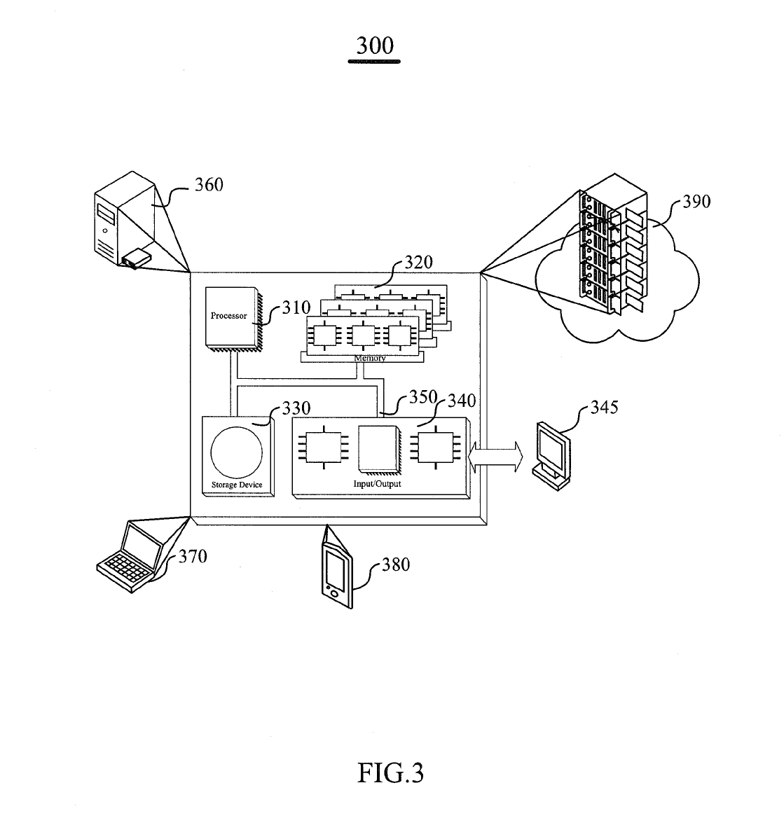

The a computer-based solitaire game may be implemented on any of a variety of game play platforms, For example, the game may be implemented in a dedicated gaming device or on-line in an Internet-based service. FIG. 1A provides a perspective drawing depicting a conventional, dedicated gaming device as may be found, for example, on a casino floor. One of skill in the art will readily recognize that FIG. 1A depicts only one of many different dedicated gaming devices which may be used in conjunction with aspects of the present disclosure. Other classes of conventional, dedicated gaming devices which may be so used include video slot machines and video lottery terminals (VLTs). For games implemented using Internet-based services, gaming devices may include personal computers or other personal computing devices (for example, including mobile devices such as personal digital assistants and smartphones as described herein infra with reference to FIG. 3).

Gaming devices that are used in conjunction with aspects of the present disclosure may typically have elements depicted by the gaming device 100 of FIG. 1A, for example including:

1) one or more display screens 10 which facilitate interactive gaming for the solitaire game platform; ¹ This rule is preferably used in a solitaire game in which each successive third card is drawn from the deck.

2) input devices 12 and/or other associated operating methods for:
i) moving and/or positioning game cards on the game screen by a player,
ii) selecting associated actions (for example, selecting the action of playing a solitaire game), and/or
iii) for accepting physical or electronic funds, paper money, coins, tokens, electronic gaming vouchers, electronic gaming credits and the like, and/or
iv) for identifying and tracking the play of individual players;

3) input devices 14 and/or other associated operating methods for providing payments, for example, via an electronic distribution of gaming vouchers, dispensing of physically-stored cash or tokens, deposits into player accounts, and the like;

4) operating software located on one or more of the gaming device and/or an associated server;

5) associated software and/or hardware (for example, including electronic or mechanical accounting meters) for tracking a number of games played, an amount of funds collected, an amount of funds paid, and the like; and

6) one or more network or other input/output interfaces for interacting with other gaming systems that may provide, for example, various management, accounting and oversight functions.

The other associated operating methods identified with input devices 12, 14 may, for example, include operating software for operating touch screen features of the one or more display screens 10.

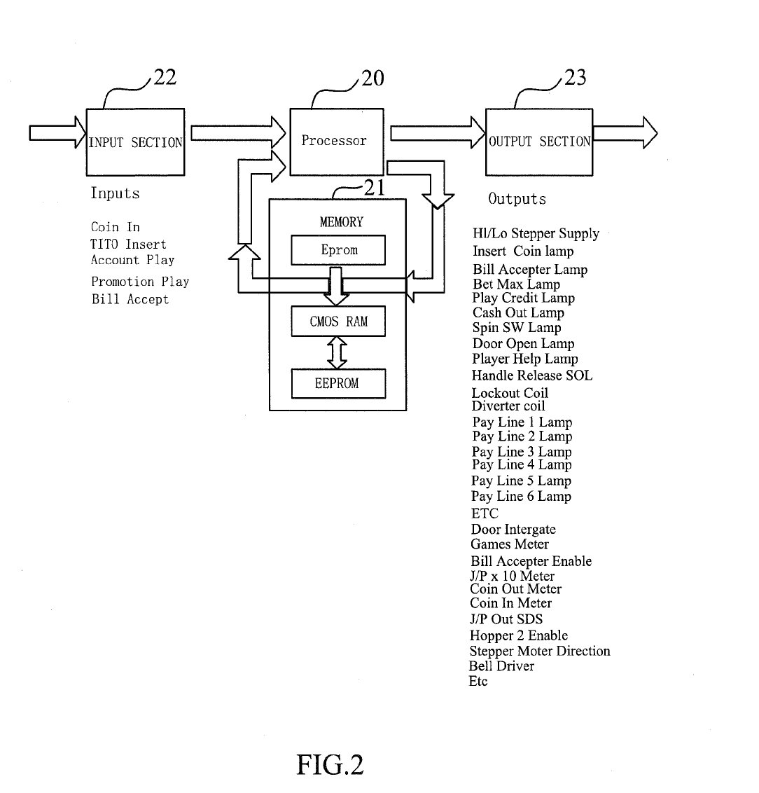

FIG. 2 provides a schematic drawing that further illustrates the elements of the gaming device 100 of FIG. 1A. As shown, the gaming device may include a processor 20 coupled to a memory 21 (for example, including one or both of volatile and non-volatile memory elements) for storing operational software of the device and associated game play and other data. An input section 22 may for example include various input devices and/or associated operating software components for accepting funds and player instructions. An output section 23 may for example include a game display and/or various other output devices (for example, including indicator lamps, electromechanical actuators and relays, meters, audio devices and bells, and the like).

FIG. 1B provides a schematic drawing depicting an internet-based gaming system 120 according to an aspect of the present disclosure. Player input and display features may be provided by a personal computer 11 or other personal computing device, which may be interconnected via a network interface to a local networking device 13 that may be coupled to a wide-area network (WAN) 15 such as the Internet. One or more servers 17 of an on-line gaming provided may also be also coupled to WAN 15, and may serve to completely execute the operating software of the game. Alternatively, for example, a portion of the operating software of the game may be downloadably installed for operation on the personal computer 11 or other personal computing device (for example, including mobile devices such as personal digital assistants and smartphones as described herein infra with reference to FIG. 3), and a remaining portion of the operating software may be installed on and executed by the one or more servers.

FIG. 3 provides a schematic drawing further depicting an exemplary computer system 300 as may be used, for example, to provide the one or more servers 17 illustrated by FIG. 1B. The computer system 300 may comprise, for example a computer running any of a number of operating systems. The above-described methods of the present disclosure may be implemented on the computer system 300 as stored program control instructions.

As depicted in FIG. 3, computer system 300 includes processor 310, memory 320, storage device 330, and input/output structure 340. One or more input/output devices may include a display 345. One or more busses 350 typically interconnect the components 310, 320, 330, and 340. Processor 310 may for example be either of a single or multi core processor.

Processor 310 may execute instructions related to aspects of the present disclosure as can be described by flow diagrams presented in one or more of the Figures. Such instructions may be stored in memory 320 or storage device 330. Data and/or information may be received and output using one or more input/output devices.

Memory 320 may store data and may be a computer-readable medium, such as volatile or non-volatile memory. Storage device 330 may provide storage for system 300, for example, to store instructions related to aspects of the present disclosure. In various aspects, storage device 330 may be a flash memory device, a disk drive, an optical disk device, or a tape device employing magnetic, optical, or other recording technologies.

Input/output structures 340 may provide input/output operations for system 300. Input/output devices utilizing these structures may include, for example, keyboards, displays 345, pointing devices, and microphones—among others. As shown and may be readily appreciated by those skilled in the art, computer system 300 for use with the present disclosure may be implemented in a desktop computer package 360, a laptop computer 370, a hand-held computer, for example a tablet computer, personal digital assistant or smartphone 380, or one or more server computers which may advantageously comprise a “cloud” computer 390.

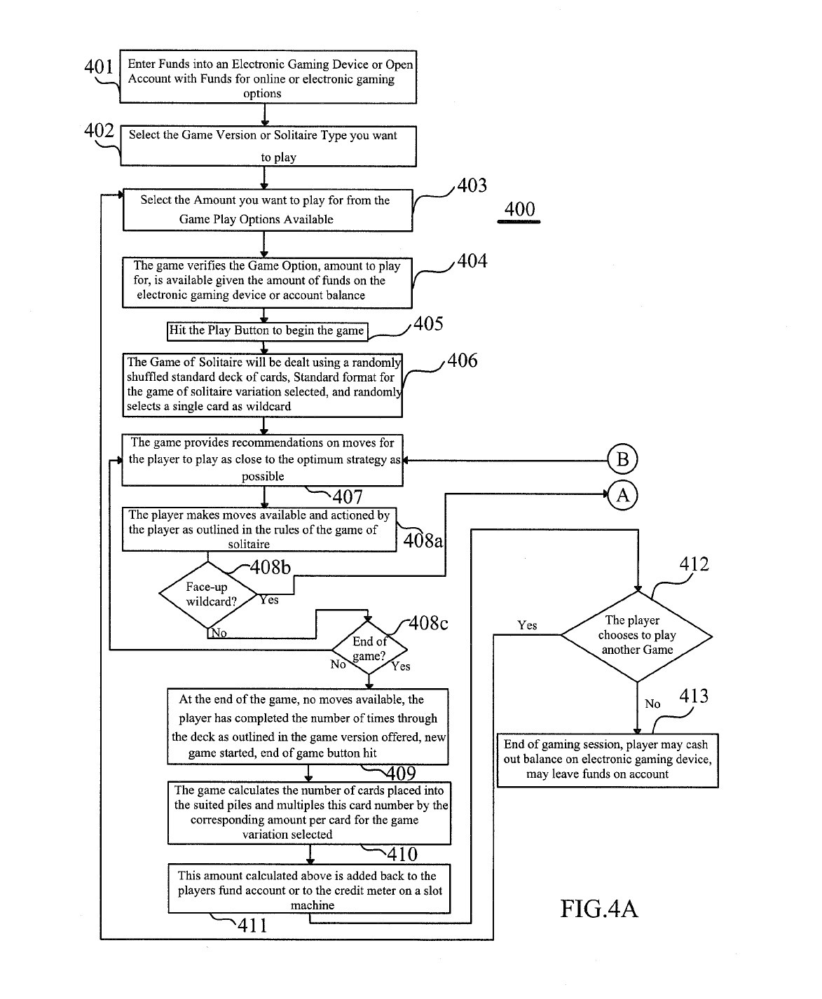

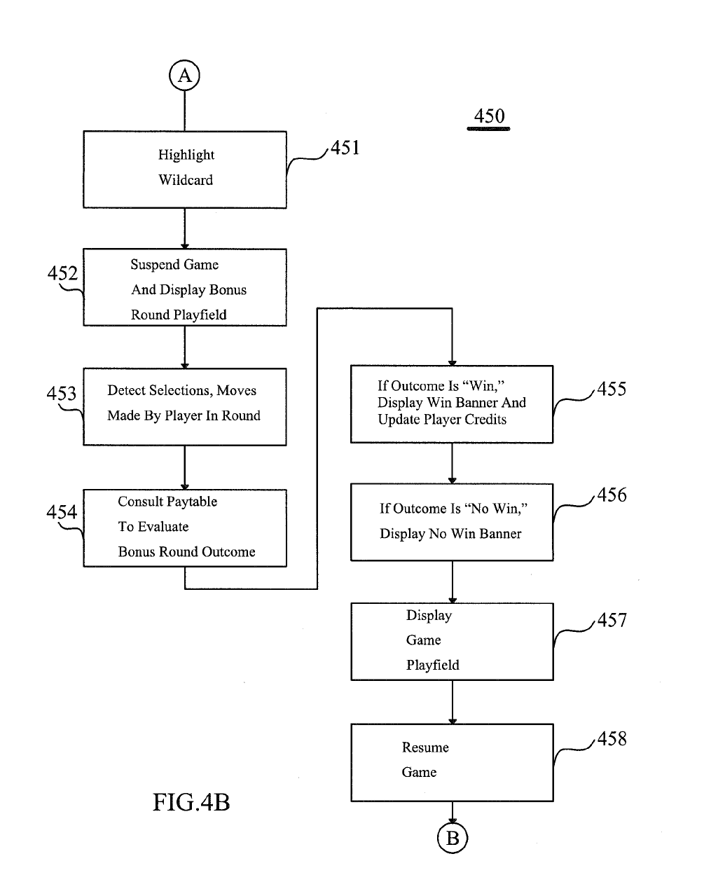

FIG. 4A is a flow diagram providing an exemplary operational overview 400 for playing a computer-based solitaire game according to an aspect of the present disclosure. At step 401, a player proceeds to enter funds for playing a solitaire game, or alternatively opens and/or accesses a player account from which electronic funds may be withdrawn for playing the game. At step 402, the player selects a particular solitaire game type (for example, a three-card draw game or a one-card draw game), and at step 403 selects a play amount (for example, one game, two games, and so on). According to aspects of the present disclosure, the game type may be more generally selectable as an “N-card draw game,” where the player may make sequential draws of N cards from a draw pile, play a bottom-most card of the N-cards drawn and others in sequence from the N-cards drawn and then from a discard pile until one card in the sequence is unplayable, and continue to make N-card draws up to N times though the deck before ending the game.

Optionally, an “Extra Deal” option may be offered to the player to enable the player to play one or more additional times through the deck when the game has not been won after the player plays N times through the deck. The player may be required to pay an additional pay-in amount for this option. Alternatively, the computer-implemented game may adjust the associated paytables in lieu of receiving an additional play-in amount. Preferably, the computer-implemented game may disable a bonus game feature (further described infra) when the “Extra Deal” feature is selected.

Returning to FIG. 4A, the game verifies the inputs provided by the player at step 404, and activates an indicator (for example, on a display screen or associated indicator lamp) instructing the player that a game is ready to be played. The player then operates an input device (for example, a game play button) at step 405 to begin that game.

At step 406, the computer-based solitaire game proceeds to prepare an electronic representation of a randomly-ordered (“shuffled”) card deck, and a display format for representing the game playfield on a display device. Optionally, at shown at step 407, the computer-based game may proceed to identify a recommended move to the player (for example, by a applying a rule set including a series of ordinally-ranked game play rules).

The player is then able at step 408a to provide inputs for making game moves in accordance with the current state of the game as displayed in the game playfield on the display screen. The player's desired moves are evaluated by the computer-implemented game (for example, by applying the series of optimum ordinally-ranked game play rules). If feasible according to the optimum ordinally-ranked game play rules, the moves are then processed in order to prepare and display an updated game playfield on the display screen.

As described supra, as the player's moves are processed, a bonus game feature (“game within a game”) may preferably be triggered when the computer-implemented game detects that one of one or more pre-determined wild cards has been exposed in an “up-card” position (for example, because it has been turned over from a hidden or “down card” position on the draw pile or on one of the card columns). The wild card is preferably selected randomly at or near the time that the randomly-ordered card deck is prepared at step 406 This card may be exposed at any time during game play, or not at all. One of skill in the art will readily recognize that alternative variants of this approach are also contemplated as aspects of the present disclosure. For example, triggering of the bonus game may be limited to the exposure of the wild card at a particular position in the playfield (for example, on one of the foundation stacks), or on the appearance of multiple wild cards, or on the appearance of multiple wildcards at respective positions in the playfield (for example, the appearance of both red kings on the foundation stacks).

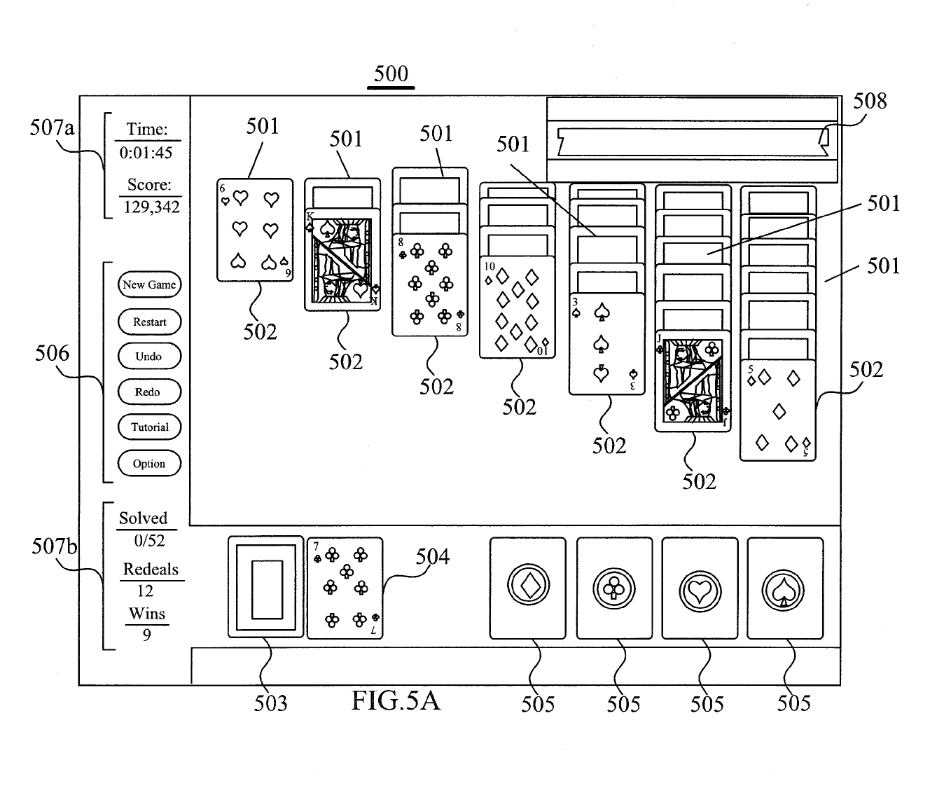

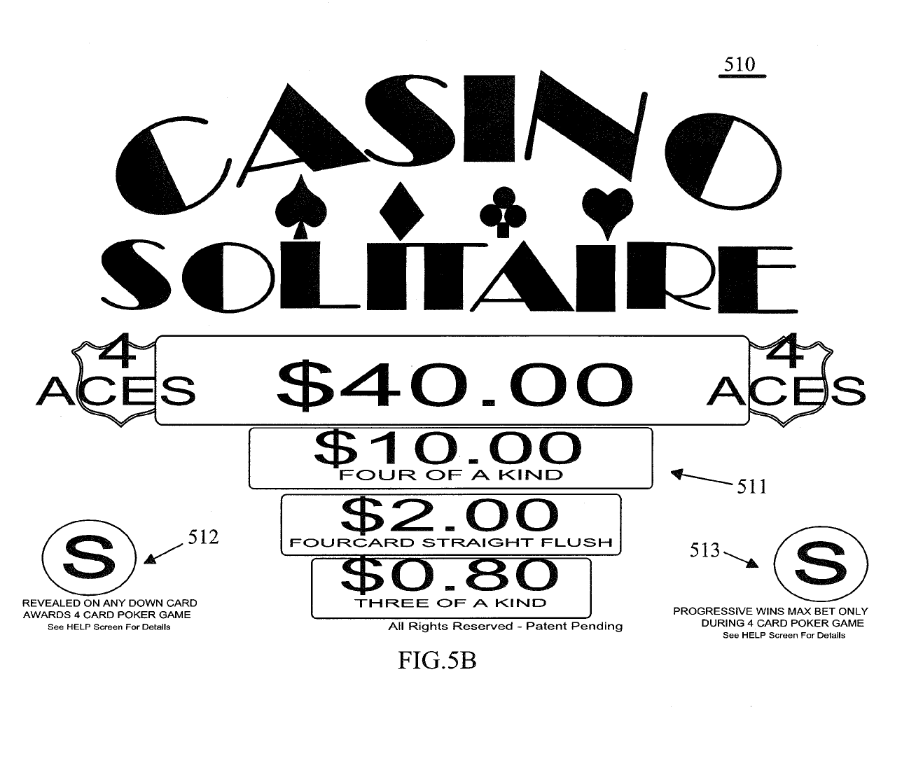

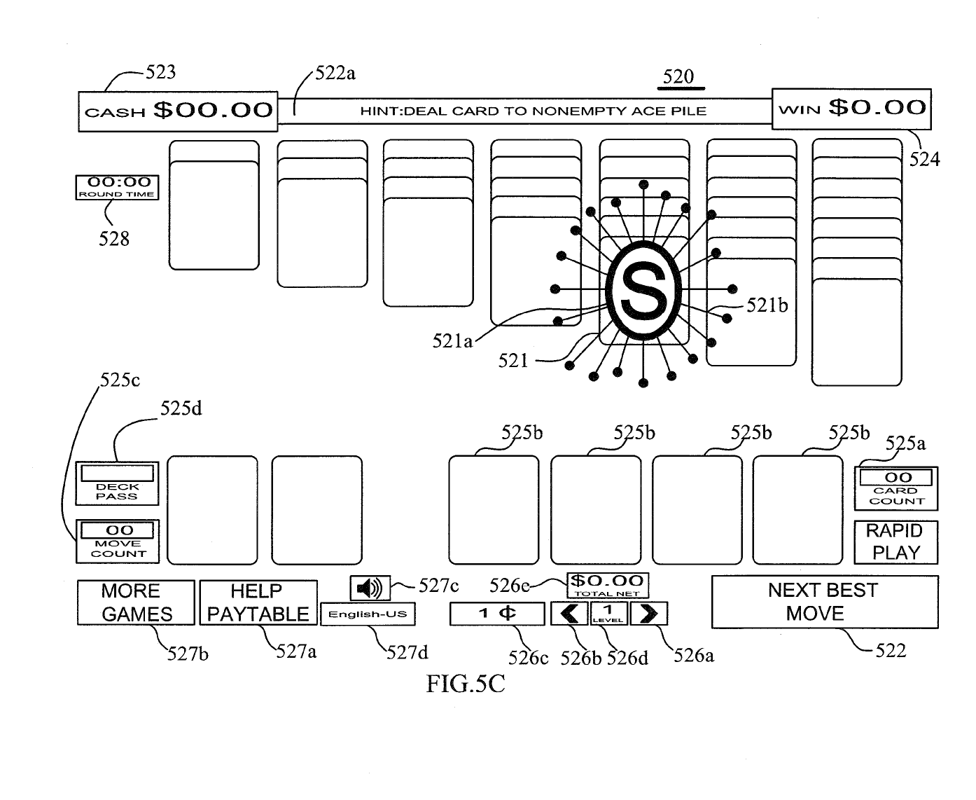

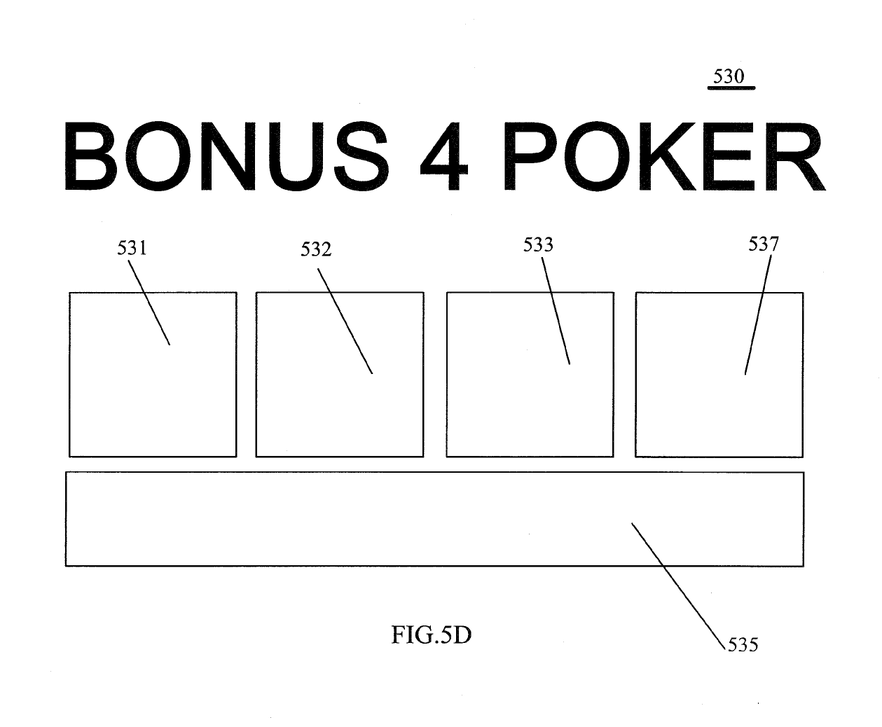

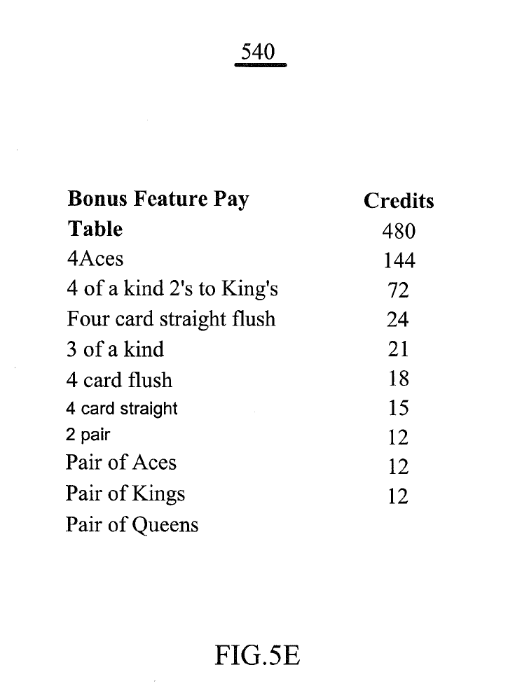

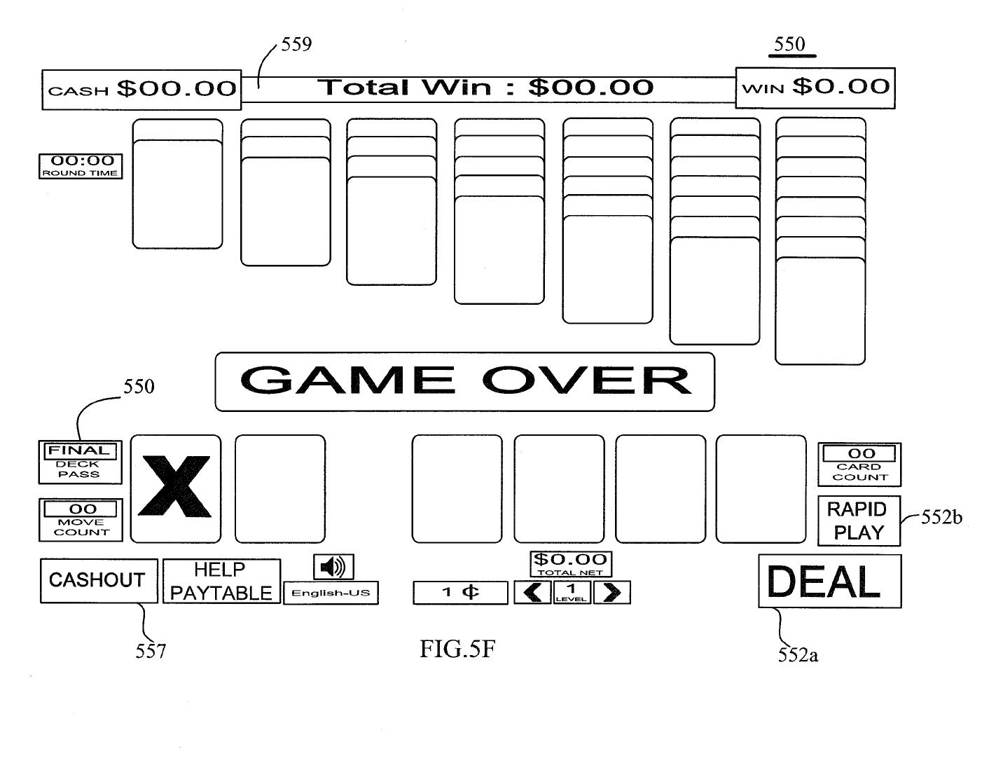

Upon detecting that the wild card has been exposed (that is, is “face-up”) at step 408b, the computer-implemented game may preferably cause a display screen viewed by the player to display the exposed wildcard in a “highlighted” form. This action is highlighted at step 451 of the exemplary bonus game overview 450 of FIG. 4B. For example, as depicted on display screen 520 of FIG. 5C, a wildcard 521 exposed on one of the card columns may be overlaid by a wildcard symbol 521 a (an encircled “S”), and an animation 521b (an outwardly expanding “fireworks” burst) may preferably alternatively or in addition be executed on the wildcard 521 in order to further draw the player's attention to the exposed wildcard 521. One of skill in the art will readily recognize that, consistent with this aspect of the disclosure, many other static and animated display means may be alternatively employed to highlight the exposed wildcard. For example, as one alternative, an animation depicting a “flashing” frame may be positioned to surround the exposed wildcard.

In order to increase interest for the player, the bonus game may be presented as one of a variety of non-solitaire games (for example, including a variety of poker-type games). Alternatively, the bonus game feature may adapt the rules and awards available in playing the current solitaire game (for example, by launching a timed game feature that pays a premium when time thresholds are met by the player in completing the current game, or by converting the award scheme for the current game to a progressive award structure including eligibility to win all or a portion of a progressive jackpot).

When the bonus game is directed to a new non-solitaire game, the computer-implemented game proceeds after highlighting the exposed wildcard to suspend the solitaire game at step 452 of FIG. 4B, and to display a new playfield for the non-solitaire game. At step 453, the computer-implemented game detects play selections and moves made by the player in playing the bonus game until detecting an end-of-game state.

FIG. 5D illustrates a playfield 530 for an exemplary bonus game (identified as “Bonus 4 Poker” or “Breakout Poker”). In this game, four card selections 531-534 are made available to the player for selection, most typically implemented as a standard touch-screen feature of the gaming device. The four card selections 531-534 may be presented before selection as face-down cards, or alternatively as spinning card reels similar to spinning reels in a conventional video slot game. In either case, the computer-implemented game prepares four randomly-ordered card decks, and simulates the timed spinning of these card decks so that the cards that are selected by the player are selected both as a function of the randomized order of the cards in each deck and the times of selection. An end-of-bonus-game state is indicated when all four cards have been selected by the player.

Returning to FIG. 4B, upon detecting an end-of-bonus-game state, the computer-implemented game consults a bonus game paytable at step 454 to evaluate an outcome of the bonus round based on the player-selected cards. An exemplary game table 540 is illustrated in FIG. 5E. In this case, for example, a bonus game result including a pair of queens, kings or aces would indicate a “win” outcome amounting to 12 credits, and a bonus game result of 4 aces would indicate a “win” outcome amounting to 480 credits. Any outcome not represented in the paytable would indicate a “no win” outcome.

Returning to FIG. 4B, upon determining a “win” outcome, the computer-implemented game preferably proceeds to display the outcome to the player at step 455 (for example, within the outcome banner 535 of FIG. 5E) and then updates a player credit counter for the solitaire game by adding the additional credits won in the outcome of the bonus game. Alternatively, if player winnings are tracked in the form of cash, the additional credits can be converted by the computer-implemented game to a cash equivalent. Upon alternatively determining a “no-win” outcome, the computer-implemented game preferably proceeds at step 456 to display a “no-win” outcome within the banner 535 of FIG. 5E. After displaying either a “win” outcome at step 455 or a “no win” outcome at step 456, the computer-implemented game proceeds at step 457 to return to displaying the solitaire game playfield as it was displayed at that time the solitaire game was suspended at step 452, to resume the game at step 458, and to return to step 408a of FIG. 4A to evaluate additional player inputs for making game moves in accordance with the current state of the game.

While the exemplary bonus game of FIG. 5D is illustrated as a four card single-draw poker game, one of skill in the art will readily recognize that a variety of other games of this type may be employed as bonus games consistent with this aspect of the disclosure. For example, other single-draw poker games having two, three or five card draws may be used as bonus games. As another example, a hybrid game (“Breakout Poker Plus”) may be employed in which a five card game is creating by adding the wild card exposed at step 408b of FIG. 4A. As yet another example, the single-draw game can be expanded to incorporate various additional card replacement features. Each of these examples is contemplated by and is in no way intended to limit these aspects of the disclosure.

Returning to FIG. 4A, the computer-implemented game continues at steps 408a,b,c to execute user-selected moves so long as no additional wild cards are exposed and an end-of-game condition has not been detected. Preferably, in the event that the all remaining cards not on the foundation stacks have been revealed and the computer-implemented game determines that the player will win the game, the computer-implemented game may execute an “AUTO WIN” function to carry out the remaining moves without further player input to end the game.

At step 409, when the computer-implemented game has determined that no additional feasible moves are available to the player and/or that another game ending event has occurred (for example, completing a predetermined number of draws through the card deck or detecting selection of an “end of game” button by the player), the game is ended. At this point in time, the game playfield provides the player with a choice to begin a new game or to end the session. To assist the player in making this decision, the computer-implemented game may at step 410, for example, calculate the number of cards placed onto the foundation stacks, and determine a payout amount for the game as a function of a per-card payout award. Alternatively, and more preferably, this calculation may have been performed incrementally throughout the game (for example, with the transfer of each card to the foundation stacks) to present a “current” payout amount to the player during the game as game play progresses.

As an alternative to providing a payout award that is calculated as a static, linear function of the number of cards placed onto the foundation stacks, the present disclosure also contemplates calculating the payout award as a function of per-card player award amounts that may, for example, vary according to the number of foundation stack cards, the identities of the foundation stack cards and/or a distribution of the transferred cards among the foundation stacks.

At steps 410 and 411, the payout amount may be accumulated, for example, with payout amounts for prior games played in a current game session either in a via the WAN 15 player's fund account and/or locally to a credit meter on the game device. At step 412, the player decides whether or not to proceed to play another game, or to conclude the game play session. If the player decides to continue, the computer-implemented game returns to step 403 for the player to select a game play amount. Otherwise, the game play session concludes at step 413, so that the computer-implemented game may enable the player to cash out an award balance or accumulate the award balance as funds on account.

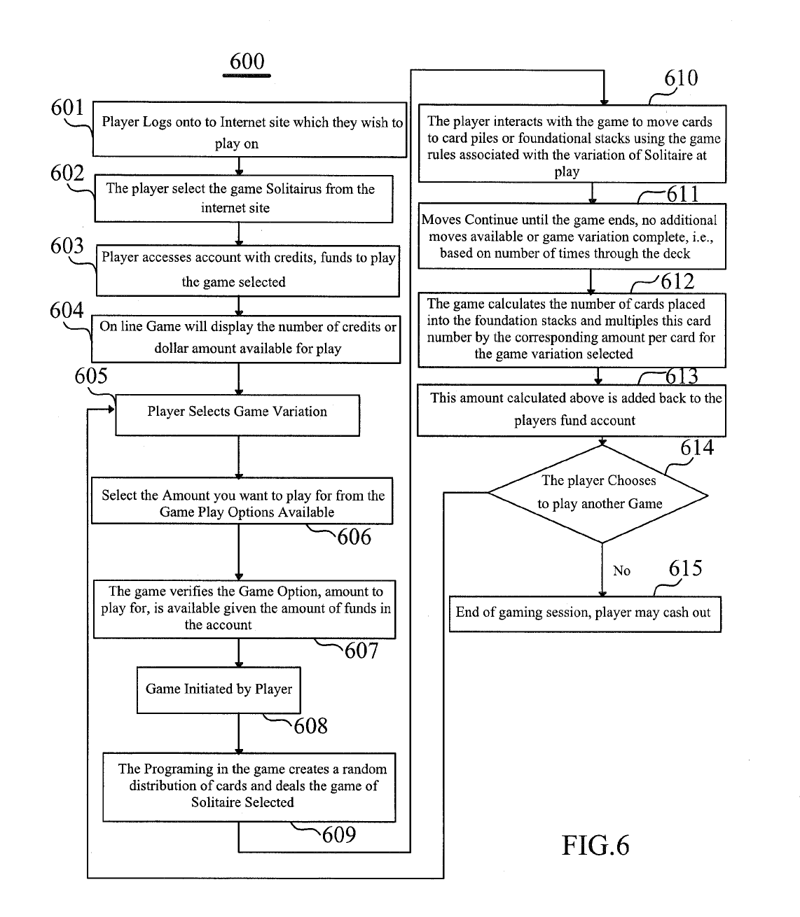

One of skill in the art will readily recognize that a variety of types of conventional solitaire games may form the basis for the computer-implemented solitaire game as described supra with reference to FIGS. 4A, 4B and infra with reference to FIG. 6. For example, a “Two Person” solitaire game may be provided enabling two players to play collaboratively with two randomized card decks to attempt to win the game. In this case, each player is be able to place cards from his or her draw pile and/or card piles on any of the foundation stacks for the two decks. In addition, each player may borrow cards from the other player's draw and/or card piles to advance the portion of the game being played with his or her deck. Alternatively, a “Two Deck” solitaire game may be provided enabling two decks to be played in this manner by a single player.

According to additional aspects of the game, several additional play features can be provided within the scope of the computer-based solitaire game. For example, one or more of these features can be provided as a bonus feature in lieu of the bonus game,

For example, a first additional feature according to aspects of the present disclosure (“Speed Solitaire”) provides a time threshold for a player to complete the solitaire. If the player meets the time threshold (either for a current game or a series of games), a bonus credit or cash award may be awarded by the computer-implemented game.

A second additional feature according to aspects of the present disclosure (“Linked Progressive Jackpot”) enables the player to be eligible for a progressive jackpot that may be accumulated, for example, as a percentage of player monies paid by a group of players into a bank of game devices or in association with on-line play. As definable in associated paytables, players may be eligible for different levels of progressive bonuses according to game outcomes.

A third additional feature according to aspects of the present disclosure (“Multi-Win Major Bonus”) enables the player to be eligible for a bonus upon winning multiple games is a defined sequence (for example, a predetermined number of games won in a row or in a defined time period). As definable in associated paytables, players may be eligible for different levels of progressive bonuses according to game outcomes. The bonuses may be provided in fixed amounts, or provided as percentage of a Linked Progressive Jackpot. It is anticipated that a maximum available bonus could reach $1,000,000 or greater, and thereby generate considerable player attraction.

These additional features may be conditionally selected by the player (for example, with the payment of an additional payment amount, or payment of a standard pay-in amount at or above a designated pay-in level). Alternatively, one or more of these additional features may be awarded to a player instead or as an alternative to playing a bonus game.

FIG. 5A depicts an exemplary display screen 500 displaying a game playfield for a computer-based solitaire game according to an aspect of the present disclosure. As depicted, the display screen depicts seven card piles 501 each having an uppermost card 502 in a face-up position, a draw pile 503 showing an uppermost card in a face down position, a currently selected positioned on a discard pile 504 in a face-up position, and four foundation stacks 505. Each of the four foundation stacks is typically associated with one suit in the card deck. In the exemplary display depicted by FIG. 5A, no cards have yet been advanced to the foundation stacks.

FIG. 5B depicts an exemplary “headline” display screen 510 according to aspects of the present disclosure. The display screen 510 may, for example, be displayed on the upper display screen 10 of the gaming device 100 of FIG. 1A for time periods before, during or after game play, or alternatively on at least a portion of the display of the game device 11 of FIG. 1B for time periods at least before or after game play. The display screen 510 of FIG. 5B may for example display a first information region 511 that provides at least partial bonus game paytable award information to encourage players to play the game. In the example provided by the first information region 511 of FIG. 5B, payout information is provided in cash equivalents rather than in a credit form. The display screen 510 may also preferably display a second information region 512 to indicate that an encircled “S” will be used to alert the player to a revealed wildcard that triggers a bonus game, and a third information region 513 that may for example instruct that a progressive award for the bonus game is available when the player has selected a “MAX BET” level of game play.

As further depicted by FIG. 5A, the display 500 may preferably display “soft” function buttons 506 that can be selected by a player (for example, by use of a pointing device, a stylus or a touch screen) to initiate various play actions of the game (for example, including a game start, a game restart, a move undo, a move redo) and/or various auxiliary actions (for example, selecting various game options including the display of a game tutorial). The display 500 may also preferably include one or more informational regions 507a, 507b that display various statistics and/or other game play information that may be of interest to the player (for example, including a time of play, a current score, a current number of cards advanced to the foundation stacks (“solved”), an indication of the number of games played (“redeals”) and/or an indication of a number of wins.

Elements of the game playfield illustrated by FIG. 5A may be most appropriately provided for particular variants of the solitaire game. The game playfield of FIG. 5A, for example, is illustrated with elements that are suitable for playing the game of Klondike solitaire. It will be appreciated by those skilled in the art that these elements may be readily adjusted to suit the type of solitaire game being played without departing generally from aspects of the present disclosure disclosed herein.

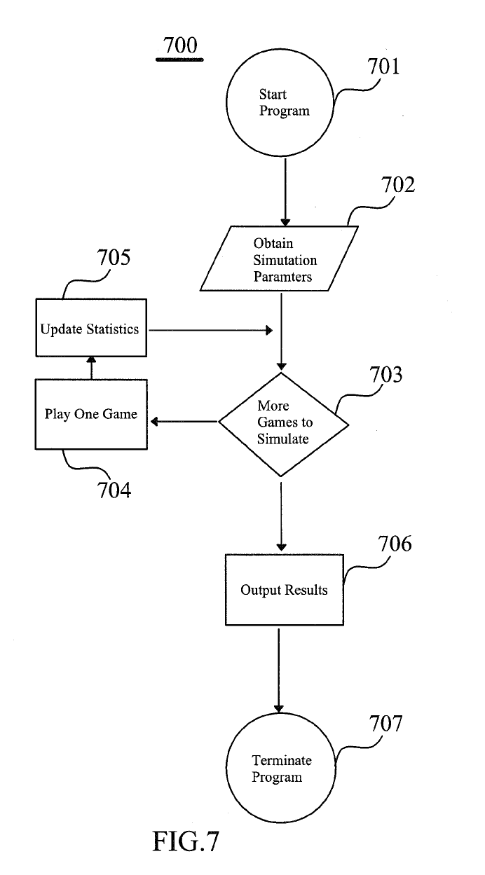

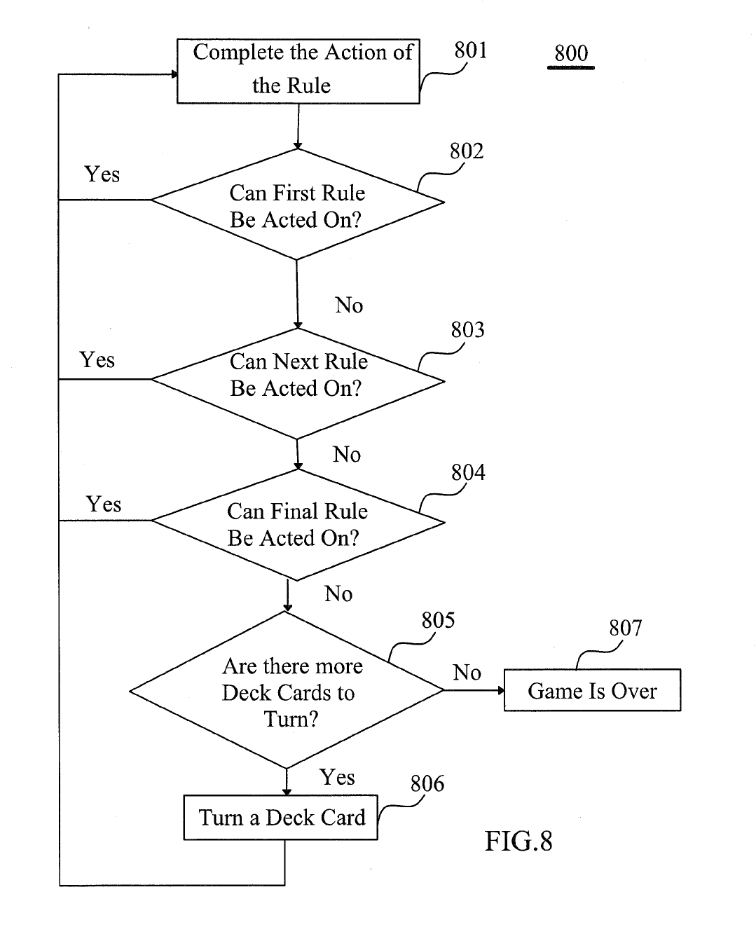

Returning to the exemplary operational overview 400 of FIG. 4A, as described supra with reference to step 407, the operating software of the computer-implemented game may preferably suggest a recommended game play move (“NEXT BEST MOVE”) to a player in advance of the move, and present this recommended move for example in an informational region 508 as depicted in FIG. 5A. According to an aspect of the disclosure, the recommendation may be preferably be provided with reference to a plurality of predetermined ordinally-ranked solitaire game play rules that are sequentially evaluated for determining the recommended move. This aspect of the disclosure is further described with reference to FIGS. 7 and 8. For example, when the recommended move is to move a topmost upward-facing card from one of the card columns to one of the foundation stacks, the computer-implemented game may provide a visual cue (for example, an animation depicting a “flashing” frame positioned to surround the card) and may provide a “Quick Tap” feature that enables the player to touch the card in order for it to be automatically moved to the foundation stack by the computer-implemented game. Alternatively, and as depicted by reference element 522 of FIG. 5C, the computer-implemented game may alternatively or in addition provide a “NEXT BEST MOVE” button which can be selected by the player to complete the move. As an additional alternative in accordance with aspects of the present disclosure, the player may selectively enable or disable a “RAPID PLAY” feature that, when enabled, causes the computer-implemented game to execute each recommended move without further player input. This feature is preferably disabled during any bonus play game.

After the player selects and inputs each game move, the operating software of the game prepares an updated game playfield for display, for example, on the display 500 of FIG. 5A or alternatively on the display 520 of FIG. 5C. The process continues until the operating software determines that the game has ended (for example, by determining that no allowable game moves are possible according predetermined optimum ordinally-ranked solitaire game play rules). At the conclusion of the game, as described supra with reference to the exemplary operational overview 400 of FIG. 4A, the operation software may determine a number of cards that have been advanced to the stacks, and calculate a corresponding payout for each of these cards as a function of a corresponding per-card payout amount. This payout amount may then, for example, be electronically added to a player's play fund account or to a credit meter if the gaming device is a video slot machine device, or alternatively be signaled to a payout device that provides the player with some physical form of payout (for example, cash, tokens, vouchers or the like). As described supra, one of skill in the art will recognize that this calculation may be equivalently performed, for example, either as incrementally as cards are advanced to the foundation stacks or in full at the conclusion of the game. After a game has ended, the player may preferably be invited to elect to play another game by selecting some designated input of the game. If elected, the game returns to a step at which the player is invited to select a new payment amount. If not elected, the game may invite the player to “cash out” according to one of the payout means described above. If game play continues, information summarizing multi-game play results may for example be prepared by the computer-implemented game and displayed as described supra in information regions 507a, 507b.

As introduced supra, FIG. 5C illustrates an exemplary display screen 520 as an alternative to the display screen 500 of FIG. 5A. Similar to the display screen 500 of FIG. 5A, the display screen 520 of FIG. 5C may, for example, be displayed on the lower display screen 10 of the gaming device 100 of FIG. 1A. One of skill in the art will recognize that some aspects of the display screens 500, 520 (for example, the configurations of the card piles 501, draw pile 503, discard pile 504 and foundation stacks 505 of FIG. 5) will vary in accordance with the type of solitaire game selected, without departing from other aspects of the disclosure.

The display screen 520 of FIG. 5C depicts a playfield of the solitaire game as a wildcard 521 has been exposed to trigger a bonus game. Other elements of the display screen 520 are relevant to game play before and after the triggering of the bonus game. For example, button 522 may be selected as described supra to execute a “NEXT BEST MOVE” recommended by the computer-implemented game. The recommended move may preferably be described in a “HINT:” field, for example as shown in banner 522a of FIG. 5C.

Several other elements of the display screen 520 provide information that may be useful to players during game play. Information box 523 indicates a current player balance associated with a player fund account and/or local credit meter from which game play can be funded, and information box 524 indicates a current award level of winnings accumulated in the current game. While boxes 523, 524 illustrate the amounts in dollars, one of skill in the art will recognize that the amounts may alternatively be represented in other currencies and/or as casino credits.

Information box 525a provides a card count indicating the number of cards that have been transferred to foundation stacks 525b, which provides an indication of game progress and current winnings Information box 525c indicates the number of cards that have been moved by the player as an alternate indicator of game progress, and information box 528 provides a current elapsed time for the present game or round. Information boxes 528, 525a and 525c may be of particular interest to a player that is operating under the time play rules of “Speed Solitaire” as described supra.

Information box 525d indicates the number of times that the player completed passes through the card deck via the draw pile. Preferably, as shown in the “deck pass” information box 558 of FIG. 5F, the information box designates the last pass that the player is eligible to make (for example, the third pass in a “three times” game) as a “FINAL” deck pass.

Buttons 526 of FIG. 5C provide a player with the opportunity to select among multi-level, multi-denominational play options provided by the game. Button 526c provides the player with the ability to select a denomination for the game (for example, 100, 250 or $1.00) that is applicable to each credit issued by the game. For example, by selecting the button 526c, a secondary button field may preferably appear for selecting one of these values.

After a denomination has been selected, the player can select a level of play by determining a current level as represented by information box 526d and toggling “increase” button 526a or “decrease” button 526c respectively in order to increase or decrease the current level. Once the denomination and level and been selected, information window 526e may preferably display an effective value of the bet. As described supra, it may be preferable to require a player to select a maximum level in order to be eligible to trigger bonus features such as a bonus game. Alternatively, players may be made eligible at more than one level, although associated paytables may provide diminished awards at the lower levels.

Several additional features are provided to the player by the display 520 of FIG. 5C. “MORE GAMES” button 527b may be provided before the start of a current game to enable the player to select an alternate type of solitaire, and/or possibly another non-solitaire video game. During game play, “HELP/PAYTABLE” button 527a may be provided for additional game information, including for example paytable information detailing the award structure for the current game.

Sound button 527c may provide the player with the ability to mute various sounds produced by the game (for example, including background music and various sounds keyed to events in the game including but not limited to card movements, bonus game awards, other game outcomes and the like). Sound button 527c may also provide the player with a secondary button field allowing for volume adjustment, customized selection of sounds and/or music, and the like. Finally, language button 527d may preferably provide the player with a secondary button field allowing the player to select among a variety of languages/dialects (for example, “English—US”) to be applied by the computer-implemented game when providing game play instructions and/or other voiced information to the player.

FIG. 5F depicts an exemplary display screen 550 that follows in sequence from the exemplary display screen 530 of FIG. 5C, as may be presented to a player at the conclusion of a game. On the display screen 550 of FIG. 5F, the NEXT BEST MOVE button 522 of FIG. 5C may for example be replaced by “DEAL” button 552a and “RAPID PLAY” button 552b. Deal button 552a may be used by the player to select a new game. Alternatively, the computer-implemented game may provide the player with the option of selecting an “AUTO PLAY” feature which is preferably configured following the conclusion of a preceding solitaire game to automatically select a denomination and level for betting, and then to initiate a new a solitaire game.

RAPID PLAY button 552b may be selected by the player to initiate the RAPID PLAY feature described supra that causes the computer-implemented game to execute each recommended move without further player input via the NEXT BEST MOVE button 552 of FIG. 5C, or alternatively by the QUICK TAP feature. In addition, the MORE GAMES button 527b of FIG. 5C may be replaced by “CASHOUT” button 557, which when selected by the player may terminate the game session and provide the player with net total winnings, for example, in the form of one or more of physical or electronic funds, paper money, coins, tokens, electronic gaming vouchers, electronic gaming credits and the like. To assist the player in making a cashout decision, the Hint field displayed by banner 522a in FIG. 5C may preferably be replaced by the “TOTAL WIN” field of banner 559 of FIG. 5F.

FIG. 6 provides an additional flow diagram depicting an exemplary operational overview 600 for playing an Internet gaming system-based solitaire game according to an aspect of the present disclosure. The overview 600 is quite similar to overviews 400, 450 previously respectively described with reference to FIGS. 4A, B, and may be further adapted in particular to include the bonus game elements the overviews 400, 450 of FIGS. 4A, B.

At steps 601 and 602 of FIG. 6, the player initially logs in to a particular Internet site of interest and selects the electronic, computer-implemented solitaire game. Once logged in, at step 603, the game accesses a player account associated with the log-in to enable the player to select a payment amount and later to post a payment amount at the conclusion of a game. At step 604, and after log-in, the computer-implemented game will preferably reveal account information including, for example, credits or dollars available for game play.

At step 605, the player selects a particular solitaire game variation or type (for example, a three-card draw game or a one-card draw game), and at step 606 selects a play amount (for example, one game, two games, and so on). According to an aspect of the present disclosure, and as described supra with reference to step 402 of FIG. 4A, the game type may be more generally selectable as an “N-card draw game,” where the player may elect to draw any number N cards from the draw pile, play the bottom-most of the N cards drawn and others in sequence from the cards drawn and the drawn pile until one of the sequence is unplayable, and play though the deck up to N times before ending the game.

Optionally, an “Extra Deal” option may be offered to the player to enable the player to play one or more additional times through the deck when the game has not been won after the player plays N times through the deck. The player may be required to pay an additional pay-in amount for this option. Alternatively, the computer-implemented game may adjust the associated paytables in lieu of receiving an additional play-in amount. Preferably, the computer-implemented game may disable the bonus game feature when the “Extra Deal” feature is selected.

At step 607 of FIG. 6, the game then verifies the inputs provided by the player, and activates an indicator (for example, on a display screen or associated indicator lamp) instructing the player that a game is ready to be played. The player then operates an input device (for example, a game play button) at step 608 to initiate that game.

At step 609, the computer-based solitaire game proceeds to prepare an electronic representation of a randomly-ordered card deck, and a display format for representing the game playfield on a display device. Although not shown, the computer-based game may then proceed to identify a recommended move to the player (for example, by a applying a rule set including a series of ordinally-ranked game play rules).

The player is then able at step 610 to provide inputs for making desired game moves in accordance with the current state of the game as displayed in the game playfield on the display screen (for example, moving a face-up card at a bottom end of one of the card piles to one of the foundation stacks). The player's desired moves are evaluated by the computer-implemented game (for example, by applying the series of ordinally-ranked game play rules). If feasible according to the ordinally-ranked game play rules, the moves are processed and an updated game playfield is displayed on the display screen.

As described supra with reference to steps 408a, b and c of FIG. 4A and step 451-458 of FIG. 4B, as the player's moves are processed at step 610 of FIG. 6, a bonus game feature (“game within a game”) may preferably be triggered, for example according to the process outlined by steps 408a, b and c of FIG. 4A and steps 451-458 of FIG. 4B. During bonus game play, the solitaire game is suspended and a bonus game playfield is displayed by the computer-implemented game on the display device. At the conclusion of the bonus game, the solitaire game playfield is restored by the computer-implemented game as it was displayed at that time the solitaire game was suspended, and game play of the solitaire game resumes.

At step 611 of FIG. 6, the player moves continue to be processed by the computer-implemented game until the game determines that no additional feasible moves are available to the player and/or that a game ending event has occurred (for example, completing a predetermined number of draws through the card deck). Then, at step 612, the computer-implemented game calculates corresponding payout for each of these cards placed onto the foundation stacks as a function of a corresponding per-card payout amount, which is accumulated in the player's fund account at step 613. Alternatively, and more preferably, and as described supra with reference to the exemplary operational overview 400 of FIG. 4A, one of skill in the art will recognize that the calculation may be performed incrementally throughout the game (for example, with the transfer of each card to a foundation stack) to present a “current” payout amount to the player during the game as game play progresses.

At step 614, the player decides whether or not to proceed to play another game, or to conclude the game play session. If the player decides to continue, the computer-implemented game returns to step 605 for the player to select a game variation or type, and continues on sequentially to step 606. Otherwise, the game play session concludes at step 615, so that the computer-implemented game may enable the player to cash out an award balance for the game play session or accumulate the award balance as funds on account. The player may for example preferably directing that any net balance in the player's account be electronically transferred to a financial institution, or alternatively elect to receive a debit card by mail in the amount of the net funds. The debit card will preferably require a PIN or some other security device in order to be activated upon receipt. One of skill in the art in casino gaming will recognize many other mechanisms effective for cashing out the player.

As compared to other games typically found on a casino floor (for example, including video poker, keno slots and video slots), video solitaire is a game that requires many player game moves and requires a significantly longer time to play. For example, while a game operator may reasonably expect that a video slot machine will be played at a game play rate of 10 to 12 spins per minute (each spin effectively representing a “play”), that operator may reasonably expect that a single game of solitaire may on average take 1 minute or more to play. As a result, the possible outcomes of solitaire games are more varied, and therefore have been more difficult to model and/or to predict. Absent an ability to prove a suitability of game outcomes according to regulatory requirements (for example, including acceptable casino hold percentages to be accumulated during play), video solitaire has not been widely introduced heretofore on the casino floor and in other gaming environments. As an aspect of the present disclosure, a method of simulating solitaire game play is disclosed that enables game outcomes to be reliably predicted, and thereby enables regulatory requirements for introducing the game to be satisfied.

FIG. 7 is a flow diagram depicting an exemplary operational overview 700 for a computer-implemented process for simulating the play of a computer-based solitaire game according to an aspect of the present disclosure. The computer-implemented process as described may, for example, may be executed using a conventional simulation software platform executed on a computer, for example, as described previously with reference to FIG. 3.

As illustrated in FIG. 7, the process begins at step 701 with an initialization step. At step 702, a series of simulation parameters are obtained to direct processing (for example, defining a number of games to be simulated, a particular rule base to be applied to the simulation, and the like). Based on these parameters, the process proceeds at step 703 to determine whether additional games need to be simulated according to the simulation parameters (in other words, have a cumulative number of simulated games reached or exceeded the defined number of games to be simulated). If a next simulated game is to be played, the process initiates a game play at step 704, captures related game play statistics at step 705 (for example, including the resulting number of cards advanced to stacks), and returns to step 703 to determine whether additional games need to be simulated. If no additional games need to be simulated, the process proceeds to output the cumulative statistical results at step 707 and then terminate at step 707.

According to an aspect of the present disclosure, the solitaire games are effectively simulated by carrying out an exemplary computer-implemented process in which game play rules are selected and applied in an optimal order (that is, from most advantageous to least advantageous). FIG. 8 is a flow diagram depicting an operational overview 800 for carrying out the exemplary computer-implemented process according to an aspect of the present disclosure.

As depicted in FIG. 8, the process begins at step 801 with completion of an action associated with a selected rule. At step 802, the computer-implemented process evaluates the first (and most advantageous) game play rule among the ordinally-ranked game play rules to determine whether this rule can be applied to select a feasible game play move based on a current status of the game (for example, as characterized by current configurations of the card piles, the card deck and the foundation stacks in the game playfield). If the first rule cannot be acted on, the process proceeds at step 803 to evaluate to the next most advantageous game play rule (and successive next most advantageous game play rules, as necessary). If a rule can be acted on, the process proceeds at step 801 to complete the action of the rule, and then begins once again to examine the applicability of the rules in the optimal sequence to determine whether another move can be made. At step 804, if none of the rules can be acted on (for example, as indicated by successively evaluating the rules and determining that none of the rules, including the final rule of the sequence, can be acted on), the process proceeds a step 805 to determine whether there are any more cards in the card deck that can be advanced to be considered for a game play. If additional cards are available, the next available card is advanced at step 806 and the process returns to step 802 to examine the applicability of the rules in optimal sequence to determine whether another move can be made. When no cards remain that have not been considered according to the current array of cards, the game is ended at step 807.

One of skill in the art will readily recognize that the individual optimal game play move rules and their ordering may vary as a function of general game play rules for each individual variation of a solitaire game. As an example, one set of ordered game play move rules for a solitaire game could consist of the following move rules in the indicated order:
1) Ace on the exposed deck to stack;
2) Ace on top of a card pile to stack;
3) deal from hidden deck if exposed deck is currently empty;
4) expose a card pile down card;
5) card pile King to empty card pile;
6) move a card chain to another card chain allowing a hidden card pile to be exposed;
7) exposed deck King to empty card pile;
8) non-Ace or King card on the exposed deck to a card chain on a card pile;
9) non-Ace card pile card to the stack;
10) Split a card chain by moving a portion to another pile in order to expose a card that can be moved to a stack;
11) non-Ace single card pile card to stack;
12) non-Ace card on exposed deck to stack;
13) card pile card to stack, which allows an exposed deck card to be moved to the stack;
14) move card off stack to a card pile, which allows a card on top of the exposed deck to be moved to a card pile or stack;
15) move card off stack to a card pile, which allows a card chain to move to expose a hidden card in the pile;
16) deal from hidden deck if exposed card is not empty;
17) reset deck (place all exposed deck cards back in hidden deck)′; and
18) move card chain with no hidden cards to another pile.
Alternatively, one of skill in the art will recognize many variants of these rule and orderings for use in alternate types of solitaire games, or for producing sub-optimal game play results (for example, if a player population is anticipated that includes a significant number of novice or casual players).

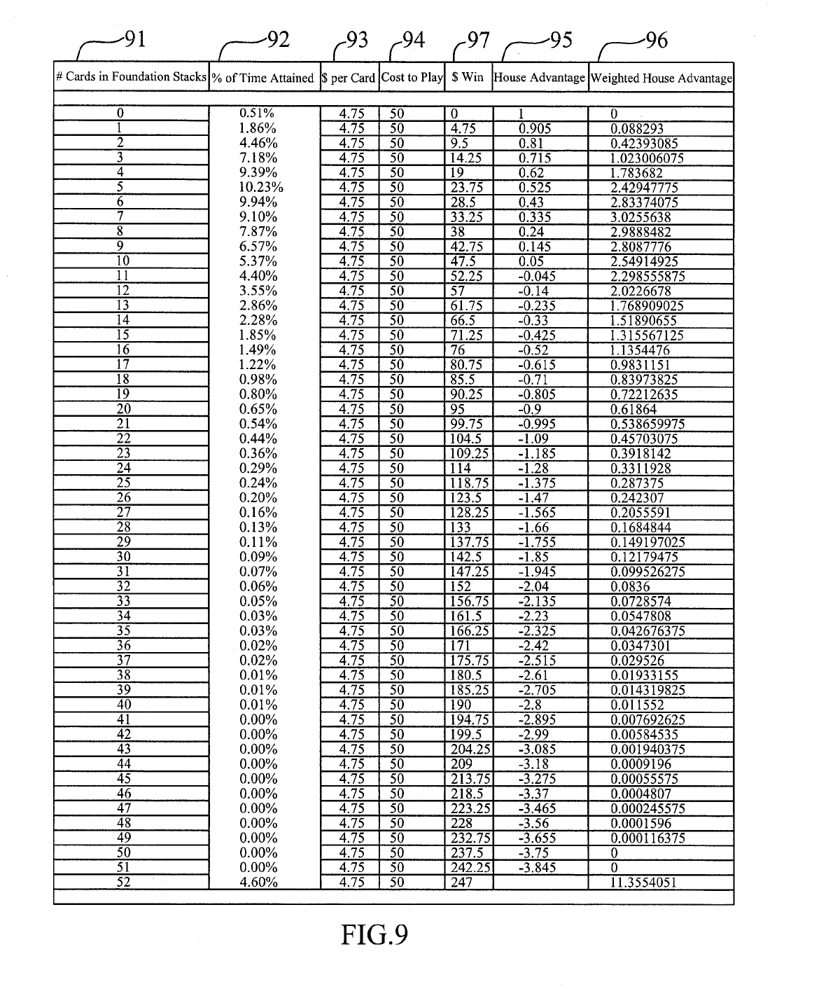

FIG. 9 is a table depicting an exemplary outcome for a simulated game play according to the processes of FIGS. 7, 8. In order to reach a statistically stable result, the number of simulated games may preferably be exceed one million simulated games. Statistics may for example be collected on a per game basis that identify the number of cards reaching the foundation stacks (91), and a percentage of games resulting in each possible number of cards reaching the stack (92), a player cost to play 94. For the selected game play cost 94 and a per card player award amount 93, a house advantage 95 for each possible number of cards reaching the foundation stacks can be calculated as the difference between the game play cost 94 and the product of the applicable number of foundation stack cards 91 and the per card player award amount 93 (payout 97, “$ Win”) divided by the selected game play cost (94). Although the example of FIG. 9 illustrates a per card player award amount that is fixed at $4.75, the present disclosure also contemplates variable per card player award amounts (94) that may, for example, vary according to the number of foundation stack cards 91, the identities of the foundation stack cards and/or a distribution of the transferred cards among the foundation stacks. The present disclosure also contemplates that the amount may vary according to a sequence of cards moved to the foundation stacks (for example, there may be no payouts fro the first 6 cards transferred to foundation stacks, a $0.10 per card payout for the next 24 cards transferred to the foundation stacks, a $0.20 per card payout for the next 11 cards transferred to the foundation stacks, and an $8.00 payout for the final card,

A weighted house advantage 96 for each possible number of cards reaching the foundation stacks can be calculated as the product of the applicable percentage 92 and payout 97. The sum of weighted house advantages 96 for all possible numbers of cards reaching the foundation stacks provides an expected payout value for the selected game play cost 94 and a per card player award amount 93. The sum of the product of applicable percentages 92 and number of foundation stack cards 91 for all possible numbers of cards reaching the foundation stacks provides an expected value for the numbers of cards reaching the foundation stacks.

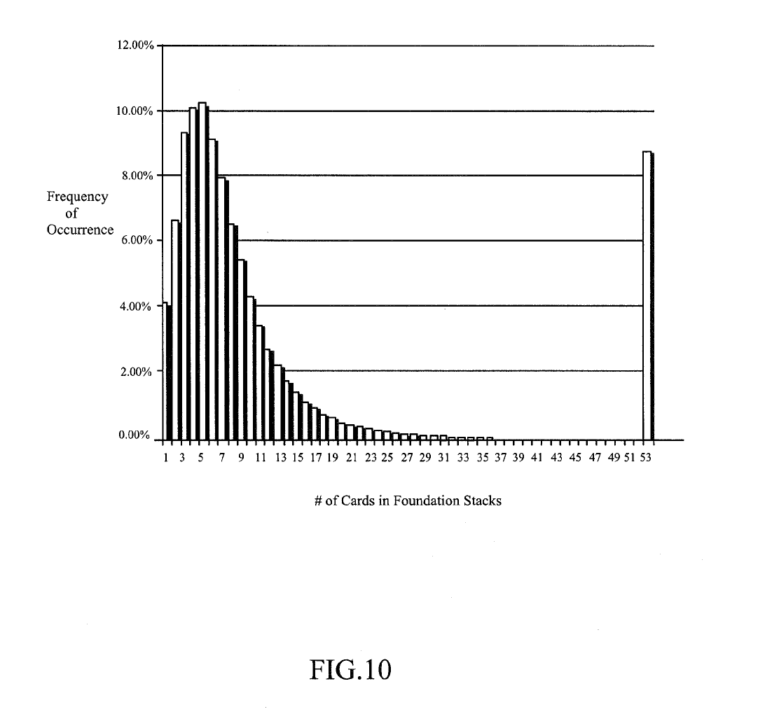

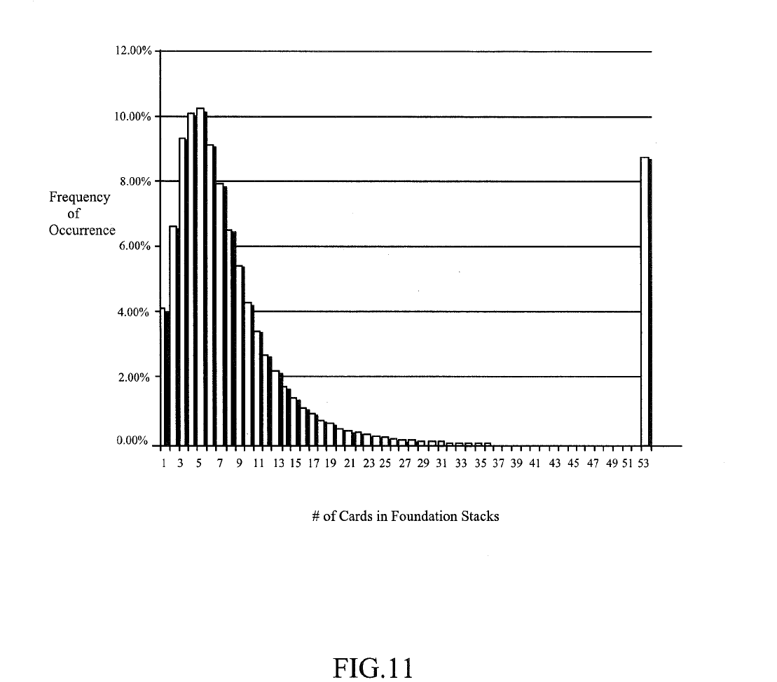

FIG. 10 presents a bar diagram depicting a frequency of occurrence (in other words, percentages 92) for possible numbers of cards transferred to foundation stacks based, for example, on the simulated game play statistics of FIG. 9. In this case, the simulation was carried out for a solitaire game in which successive third cards in the card deck are selected, moving three times through the deck. FIG. 11 presents similar results for a solitaire game simulation in which each card in a card deck is selected moving one time through the deck. Comparatively, and perhaps surprisingly, the distributions of numbers of cards advanced to stacks in each figure are quite similar. In each case, the simulation results show that fifteen or fewer cards will be advanced to the stacks in approximately eighty-five percent of all games

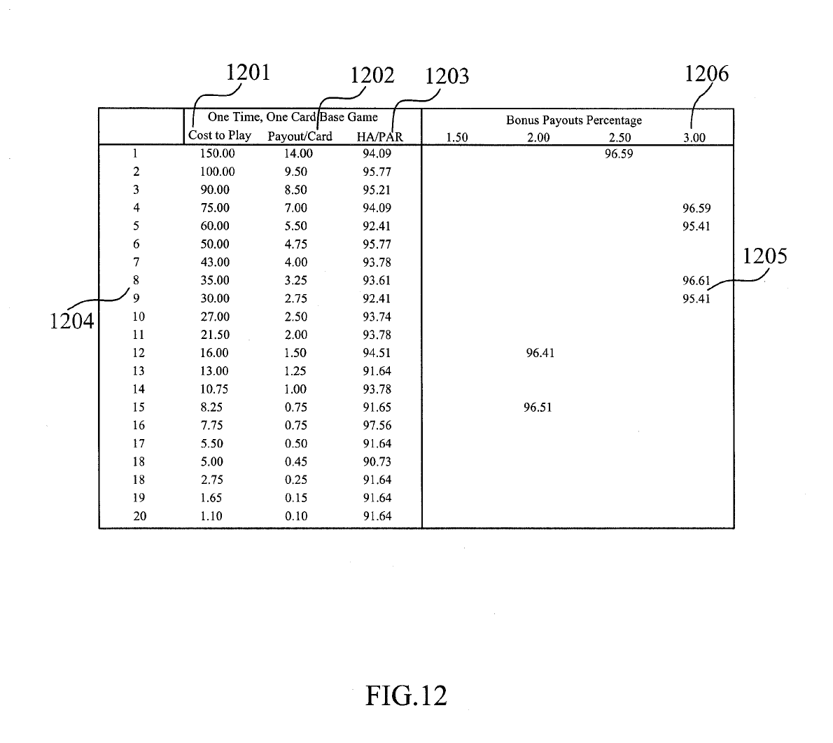

FIG. 12 presents a first table illustrating payout information based on simulated game play results according to an aspect of the present disclosure. Tables of this type for other traditional casino games are often referred to as “PAR sheets.” Fig. illustrates payout information for simulated game results based on games played by applying a “one-time, one card” selection from the card deck. A “hold advantage” (HA/PAR) 1203 is calculated for a variety of selected cost to play/payout per card pairings 1201, 1201. For an example 1204, the payout information shown includes a cost to play 1301 of $35.00, a payout per card 1302 of $3.25, and a HA/PAR 1303 of 93.61. Interpreted, this indicates that a game operator applying this pairing over time would expect to pay out 94.61% of the monies paid by all players to play, thereby retaining retain 6.39% of these monies as the expected hold percentage. FIG. 12 further illustrates the impact of adding additional bonus payout features to this game. For an example 1205, if an additional 3% bonus payout 1206 is granted under certain “bonus” conditions (for example, in the event that the player wins the game by playing all cards on the stacks or uncovers a particular wild card hidden in one of the card piles during game play), HA/PAR is 96.61 (reducing the expected hold percentage to 3.39%).

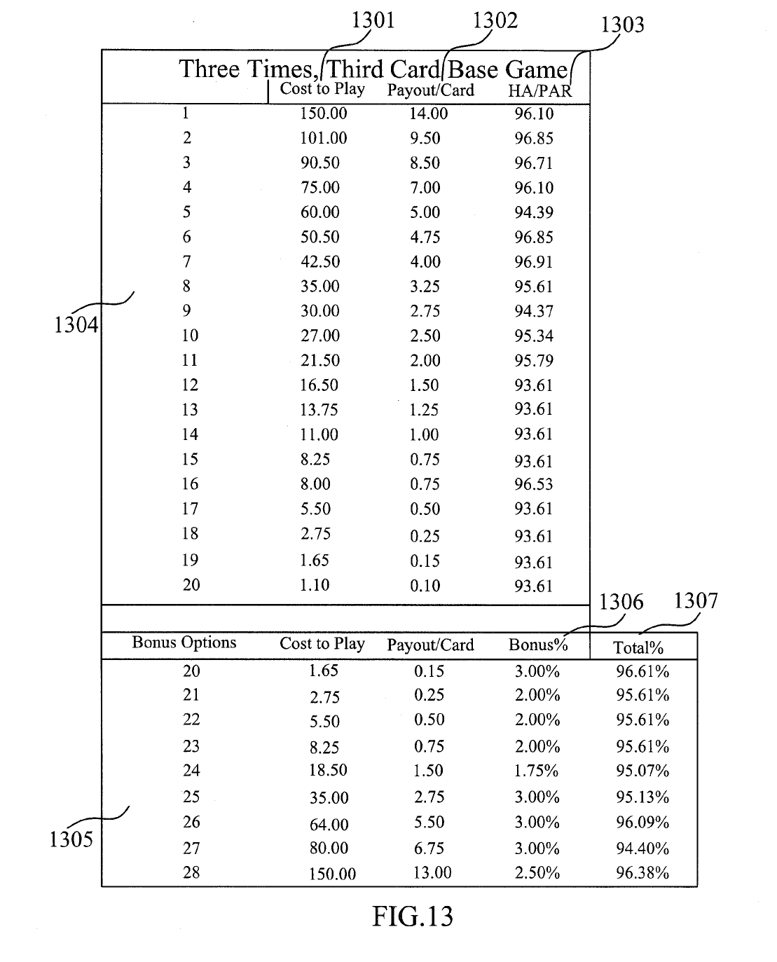

FIG. 13 is presents a second table illustrating similar payout information based on simulated games played by applying a “three-time, third card” selection from the card deck. In this case, for an example 1304, the payout information shown includes a cost to play 1301 of $35.00, a payout per card 1302 of $3.25, and a HA/PAR 1303 of 95.61. Interpreted, this indicates that a game operator applying this pairing over time would expect to pay out 95.61% of the monies paid by all players to play, thereby retaining retain 4.39% of these monies as the expected hold percentage. As an alternative to example 1304 that includes an additional bonus feature as described supra, an example 1305 shows payout information including a cost to play 1301 of $35.00, a payout per card 1302 of $3.25, a bonus percentage 1306 of 3% and a total payout percentage 1307 HA/PAR of 95.61 (and expected hold percentage of 4.39%). As compared to the example 1304, the game operator's expected hold percentage is held constant with the introduction of an additional bonus opportunity and reduction in the payout per card for cards transferred to the foundation stacks. As implied by the examples 1304, 1305, the game simulations can be advantageously used by game operators to identify a variety of game variants (in this case, with and without bonus features) that can be offered without affecting a long-term hold percentage target that has been approved by regulators for the game.

Heretofore unavailable for games having a play complexity like that of solitaire, these tables as derived from the simulated game play statistics provide substantial insights about game play to game operators and credible reassurance to regulators that the games as administered by the game operators will not violate regulations concerning the hold advantage maintained by the operators.

At this point, while we have presented this disclosure using some specific examples, those skilled in the art will recognize that our teachings are not so limited. Accordingly, this disclosure should be only limited by the scope of the claims attached hereto.

1. A method of operating a computer-based solitaire game comprising the steps of:
verifying payment of a player's fee;
generating an electronic representation of a randomly-ordered card deck for playing a game;
generating an electronic representation of a playfield based upon the randomly-ordered card deck;
receiving player inputs at a user interface for advancing the game;
accepting the player inputs according to a predetermined set of game play rules,
updating the playfield according to the player inputs, the predetermined game play rules and the card deck; and
providing a payout to the player that is calculated as a function of a per-card payout award and a number of cards transferred to foundation stacks during the game,
wherein the per-card payout award is determined as a function of an expected number of transferred cards per game and the player's fee,
wherein the expected number of transferred cards is determined as a function of a discrete probability density function representing each possible number of cards transferred, the discrete probability density function being calculated from game outcomes produced in a multi-game a multi-game simulation, and
wherein the number games simulated in the multi-game simulation is selected to provide a statistically stable result.

2. The method of claim 1, wherein the providing step includes the steps of:
determining an actual number of cards transferred to foundation stacks at a conclusion of the game, and;
calculating the payout at the conclusion of the game.

3. The method of claim 1, wherein the providing step includes the step of:
calculating the payout incrementally as each of the number of cards is transferred to the foundation stacks.

4-24. (canceled)

25. The method of claim 1, further comprising the steps of:
providing game play recommendations to the player according to the game play rules; and
receiving a user input that instructs the computer-based solitaire game to automatically execute each game play recommendation;
wherein the game play rules comprise a set of predetermined ordinally-ranked solitaire optimal game play rules and each recommendation satisfies a game play rule having a highest ordinal ranking among the ordinally-ranked solitaire optimal game play rules.

26. A method of operating a computer-based solitaire game comprising the steps of:
generating an electronic representation of a randomly-ordered card deck for playing a solitaire game;
identifying one of the cards in the randomly-ordered card deck as a wild card;
receiving player inputs at a user interface for advancing the solitaire game;
generating an electronic representation for displaying a playfield of the solitaire game based upon the randomly-ordered card deck, the received player inputs and predetermined game play rules, the playfield of the solitaire game including a plurality of card piles on which one or more cards in the randomly-ordered card deck are positioned in a face-up orientation;
determining whether one of the one or more face-up cards is the wild card; and
upon determining that one of the one or more face-up cards is the wild card, performing the additional steps of:
suspending the solitaire game,
generating an electronic representation for displaying a playfield of the bonus game,
receiving player inputs at the user interface for advancing the bonus game,
updating the playfield of the bonus game according to the player inputs for advancing the bonus game,
terminating the bonus game upon detecting an end of game condition:
displaying the playfield for the suspended solitaire game, and
resuming the solitaire game.

27. The method of claim 26, wherein the bonus game comprises a non-solitaire type game.

28. The method of claim 27, wherein:
the bonus game comprises a draw type poker game and,
the player inputs cause cards to be drawn randomly from a second randomly-ordered card deck.

29. The method of claim 28, wherein the bonus game comprises a four-card draw-type poker game.

30. The method of claim 28, wherein the bonus game comprises a five-card poker game in which four cards are randomly drawn from the second randomly-ordered card deck and a fifth card is drawn as the wild card.

31. The method of claim 26, wherein the terminating step further comprises the steps of:
determining whether a the bonus game resulted in a win or no-win outcome according to a bonus game paytable,
displaying a win indicator in the playfield of the bonus game when the bonus game results in a win outcome,
determining a bonus game award amount for the win outcome according to the bonus game paytable, and
adding the bonus game award amount to a player award associated with the solitaire game.

32. A method of operating a computer-based solitaire game comprising the steps of:
generating an electronic representation of a randomly-ordered card deck for playing a solitaire game;
receiving player inputs at a user interface for advancing the solitaire game;
generating an electronic representation for displaying a playfield of the solitaire game based upon the randomly-ordered card deck, the received player inputs and predetermined game play rules, the playfield of the solitaire game including a plurality of card piles on which one or more cards in the randomly-ordered card deck are positioned in a face-up orientation;
identifying the occurrence of a predetermined game play event;
initiating a bonus feature of the solitaire game as a result of identifying the predetermined game play event.

33. The method of claim 32, wherein the predetermined game play event is the appearance of a predetermined wild card from the randomly-ordered card deck as an upward facing card in the playfield, further including the steps of:
determining whether one of the one or more face-up cards is the wild card; and
upon determining that one of the one or more face-up cards is the wild card, initiating the bonus feature of the game.

34. The method of claim 32, wherein the initiated bonus feature is a timed play feature, whereby the player earns a premium award when an elapsed time to play to finish the solitaire game is less than a predetermined threshold.

35. The method of claim 32, wherein the initiated bonus feature comprises player eligibility for an enhanced award.

36. The method of claim 34, wherein the enhanced award is a linked progressive jackpot.

37. The method of claim 32, wherein the predetermined game play event is winning a predetermined number of games by the player according in a defined sequence.

38. The method of claim 32, wherein the step of receiving player inputs at a user interface includes the step of receiving a user input selecting an N card draw game, for which the predetermined game rules allow the player to make sequential draws of N cards from a draw pile, play a bottom-most card of the N-cards drawn and others in sequence from the N-cards drawn and a discard pile until one card in the sequence is unplayable, and continue to make N-card draws up to N times though the card deck before ending the game, wherein N is an integer less than or equal to a total number of cards in the card deck.

39. The method of claim 38, wherein the step of receiving player inputs at a user interface includes the step of receiving another user input selecting an N+1 times though the card deck play option.
